(19) United States
(12) Patent Application Publication
(10) Pub. No.: US 2007/0137770 A1
(43) Pub. Date: Jun. 21, 2007

(54) Transport belt and method of making thereof

(76) Inventors: Arved H. Westerkamp, Dettingen/Erms (DE); Hubert Walkenhaus, Kerpen (DE)

Correspondence Address: HERSHKOVITZ & ASSOCIATES, 2845 DUKE STREET, ALEXANDRIA, VA, 22314, US

(21) Appl. No.: 11/601,738

(22) Filed: Nov. 20, 2006

(30) Foreign Application Priority Data
Dec. 17, 2005 (DE) 10 2005 060 525.7

(51) Int. Cl. D21F 11/00; B32B 29/02; B32B 5/02; D21F 1/10

(52) U.S. Cl. 156/176; 162/904; 139/383 B; 442/59; 162/348

(57) ABSTRACT

A transport belt and method of making a transport belt for a web-processing machine, in particular a paper machine, paperboard machine or tissue machine, is provided. The transport belt has a load-bearing carrier structure which is covered at least in sections by a polymer areal structure, as the result of which the polymer areal structure and the load-bearing carrier structure make contact with each other in sections either indirectly or directly. The contact region between the load-bearing carrier structure and the polymer areal structure comprises sections in which the carrier structure can move relative to the polymer areal structure.

### CROSS-REFERENCE TO RELATED APPLICATIONS

The present application claims priority under 35 U.S.C. 119 of German Patent Application No. 10 2005 060 525.7, filed on Dec. 17, 2005, the disclosure of which is expressly incorporated by reference herein in its entirety.

### BACKGROUND OF THE INVENTION

1. Field of the Invention

The present invention relates to a transport belt and a method of making thereof.

Transport belts are used on a paper machine, for example, wherever it is necessary to bridge open draws during the conveyance of the paper web between different presses in the press section or between the press section and the drying section. Such transport belts are also used, however, to convey a paper web through one or more press nips. Such transport belts can be the so-called ENP belts (ENP=Extended Nip Press), shoe press belts or smoothing belts.

2. Discussion of Background Information

The transport belts known from the prior art have a load-bearing carrier structure which is formed by one or more fabrics for example, and usually is fully covered by a polymer areal structure, whereby the carrier structure has a strong and intrinsic connection with the polymer areal structure in the contact region. In this case, the transport belt is reinforced by the carrier structure.

Often an undesirably high rigidity of the transport belt results from the strong and intrinsic connection between the carrier structure and the polymer areal structure in which it is embedded.

The high rigidity of such transport belts has a negative effect during their installation on the paper machine on account of the high bending forces which need to be applied thereby. High bending forces need to be applied likewise during the operation of such transport belts, thus resulting in a higher loading of the paper machine.

### SUMMARY OF THE INVENTION

According to the present invention, a transport belt of the type initially referred to is modified such that the previously described disadvantages are eliminated or at least reduced.

According to the present invention, there is provided a transport belt, such as a web-processing machine, in particular, a paper machine, a paperboard machine or a tissue machine, with the features of having a load-bearing carrier structure covered at least in sections by a polymer areal structure, wherein the polymer areal structure and the load-bearing carrier structure make contact with each other in sections one of indirectly or directly, and a contact region between the load-bearing carrier structure and the polymer areal structure is formed and comprises sections wherein the load-bearing carrier structure moves relative to the polymer areal structure. According to the present invention, there is also provided a method of making a transport belt comprising providing the load-bearing carrier structure and the polymer areal structure as described herein. The load-bearing carrier structure is also referred to hereinafter as the carrier structure.

As the contact region between the carrier structure and the polymer areal structure comprises sections in which the carrier structure can move relative to the polymer areal structure, the load-bearing carrier structure is “floatingly” embedded in the polymer areal structure at least in sections. Hence it is possible during bending of the transport belt for at least a part of the carrier structure in the contact region to move relative to the polymer areal structure, thus greatly reducing the bending rigidity of the transport belt.

Advantageous further aspects of the present invention can be seen according to the various embodiments as described herein.

The relative movability between the carrier structure and the polymer areal structure in the contact region can be provided in that an adhesive connection is absent between the load-bearing carrier structure and the polymer areal structure in sections which the load-bearing carrier structure moves relative to the polymer areal structure.

According to various embodiments, the carrier structure can comprise one or more textile areal structures, whereby one textile areal structure can comprise alone or in combination for example: one or more fabrics, one or more thread plaitings, one or more thread knittings, one or more extruded or pressed lattice structures, one or more membranes, or one or more fleeces.

According to these embodiments, it should be noted that threads extending in the MD direction for example can be “floatingly” mounted in the polymer areal structure, whereas threads extending in the CD direction are fixed to the areal structure, i.e. cannot move relative to it. The transverse rigidity often required of the transport belt, which is necessary for good conveyance of the belt on the machine, is thus retained whereas rigidity in the longitudinal direction of the transport belt is reduced.

According to various embodiments of the present invention, the carrier structure and the polymer areal structure can be essentially immovable relative to each other in sections of the contact region extending in the transverse direction of the transport belt whereas the carrier structure and the polymer areal structure are movable relative to each other in sections of the contact region extending in the longitudinal direction of the transport belt.

According to one aspect of the invention, a separating layer is positioned in the contact region between the carrier structure and the polymer areal structure at least in sections, whereby the separating layer comprises a material that provides a reduced frictional resistance between the carrier structure and the polymer areal structure. The bending rigidity of the transport belt can be selectively established by the amount of selective frictional resistance.

According to one or more embodiments, at least the surface of the carrier structure and/or at least the surface of the polymer areal structure can be treated or constructed in the contact region at least in sections such that the frictional resistance between the carrier structure and the polymer areal structure in the contact region is reduced. One possibility for reducing the frictional resistance is, for example, for the materials of the polymer areal structure and the reinforcement structure in the contact region to have a mutually different surface energy.

Furthermore, the carrier structure can be treated with the so-called dope or spinning dope. Dope and spinning dope are understood to be chemical finishing agents for raw textile materials (e.g. fibers) or semifinished/finished products (e.g. threads, fabrics, plaitings) which are applied thereto in order to selectively establish their properties.

According to various embodiments of the present invention, the threads of the carrier structure, or at least some of them, can be covered with the separating layer at least in sections, whereby the material forming the separating layer can be comprised of wax, starch, oil or silicone for example, either alone or in combination.

The separating layer can be formed by a material which is more flexible than the polymer areal structure and the carrier structure and is fixed to the polymer areal structure and the carrier structure, meaning adhesively connected to them for example.

According to various embodiments of the present invention, the polymer areal structure can completely cover the carrier structure. If, for example, the carrier structure is constructed as a fabric and is movable in the entire region of contact with the polymer areal structure relative thereto, and if the polymer areal structure completely covers the fabric, then the polymer areal structure on either side of the carrier structure is joined together by the polymer areal structure which penetrates the meshes of the fabric.

The transport belt of the present invention has one side which can be brought into contact with the material web and is formed by a first surface of the polymer areal structure.

According to another embodiment of the present invention, a second surface of the polymer areal structure can lay opposite the first side to form the side of the transport belt which can be brought into contact with the machine.

One or more embodiments of the present invention provide for the transport belt to be impermeable to fluid.

Furthermore, the first surface can be hydrophilic or hydrophobic. However, it is also possible for the first surface to comprise hydrophilic and hydrophobic sections. Furthermore, the first surface can be smooth or textured. Hence the first surface can have a roughness in the range from RZ=2 to 80 μm according to ISO 4287, Part I, for example.

Furthermore, the polymer areal structure in the region of the first surface can be comprised of a plastic material with a hardness in the range of approximately Shore A 40 to Shore A 100, whereby filler materials are embedded in the plastic material for example. According to other embodiments, the first surface can be one that is described in EP 0 576 115 B1 for example, which is incorporated by reference herein in its entirety.

According to one aspect of the present invention, the transport belt for a web-processing machine comprises a load-bearing carrier structure covered at least in sections by a polymer areal structure, in which the polymer areal structure and the load-bearing carrier structure make contact with each other in sections either one of indirectly or directly. A contact region can be formed between the load-bearing carrier structure and the polymer areal structure, comprising sections in which the load-bearing carrier structure is moveable relative to the polymer areal structure.

According to other aspects of the present invention, an adhesive connection can be absent between the load-bearing carrier structure and the polymer areal structure in sections where the load-bearing carrier structure is moveable relative to the polymer areal structure. The load-bearing carrier structure can comprise at least one of a fabric, a thread plaiting, and a thread knitting. A separating layer can be positioned in a contact region between the load-bearing carrier structure and the polymer areal structure at least in sections. The load-bearing carrier structure can comprise threads and the threads can be covered with the separating layer at least in sections. The separating layer can comprise a material that provides a reduced frictional resistance between the load-bearing carrier structure and the polymer areal structure in the contact region. The separating layer can comprise at least one of wax, starch, oil, and silicone. The polymer areal structure can completely cover the load-bearing carrier structure. A first surface of the polymer areal structure can form a first side of the transport belt which contacts with a material web when the material web is placed on the web-processing machine. A second surface of the polymer areal structure lying opposite the first side can form a second side of the transport belt which contacts with the web-processing machine when the transport belt is placed on the web-processing machine. The load-bearing carrier structure and the polymer areal structure can be essentially immovable relative to each other in sections of the contact region extending in a transverse direction of the transport belt and the load-bearing carrier structure and the polymer areal structure can be movable relative to each other in sections of the contact region extending in a longitudinal direction of the transport belt. The transport belt can be impermeable to fluid. The transport belt can be configured for one of a paper machine, a paperboard machine or a tissue machine.

Still according to another aspect of the invention, a transport belt for a web-processing machine can comprise a load-bearing carrier structure covered at least in sections by a polymer areal structure, in which the polymer areal structure and the load-bearing carrier structure make contact with each other in sections either one of indirectly or directly, a contact region being formed between the load-bearing carrier structure and the polymer areal structure, comprising sections wherein the load-bearing carrier structure is moveable relative to the polymer areal structure, an adhesive connection being absent between the load-bearing carrier structure and the polymer areal structure in sections where the load-bearing carrier structure is moveable relative to the polymer areal structure, the load-bearing carrier structure comprising at least one of a fabric, a thread plaiting, and a thread knitting, a separating layer being positioned in a contact region between the load-bearing carrier structure and the polymer areal structure at least in sections, and the separating layer comprising at least one of wax, starch, oil, and silicone.

According to another aspect of the present invention, methods for making a transport belt for a web-processing machine are also provided. According to one aspect of the present invention, the method for making a transport belt for a web-processing machine comprises providing a load-bearing carrier structure covered at least in sections by a polymer areal structure, in which the polymer areal structure and the load-bearing carrier structure make contact with each other in sections either one of indirectly or directly, and forming a contact region between the load-bearing carrier structure and the polymer areal structure, the contact region comprising sections wherein the load-bearing carrier structure is moveable relative to the polymer areal structure.

According to one or more aspects of the present invention, an adhesive connection can be absent between the load-bearing carrier structure and the polymer areal structure in sections where the load-bearing carrier structure is moveable relative to the polymer areal structure. A load-bearing carrier structure can comprise at least one of a fabric, a thread plaiting, and a thread knitting. The method of making a transport belt can further comprise positioning a separating layer in a contact region between the load-bearing carrier structure and the polymer areal structure at least in sections. The load-bearing carrier structure can comprise threads and the threads can be covered with the separating layer at least in sections. The separating layer can comprise a material that provides a reduced frictional resistance between the load-bearing carrier structure and the polymer areal structure in the contact region. The separating layer can comprise at least one of wax, starch, oil, and silicone. The polymer areal structure can completely cover the load-bearing carrier structure. The transport belt can be impermeable to fluid.

According to other aspects of the present invention, a method of making a transport belt for a web-processing machine comprises providing a load-bearing carrier structure covered at least in sections by a polymer areal structure, in which the polymer areal structure and the load-bearing carrier structure make contact with each other in sections either one of indirectly or directly, forming a contact region between the load-bearing carrier structure and the polymer areal structure, the contact region comprising sections in which the load-bearing carrier structure is moveable relative to the polymer areal structure, an adhesive connection being absent between the load-bearing carrier structure and the polymer areal structure in sections where the load-bearing carrier structure is moveable relative to the polymer areal structure, the load-bearing carrier structure comprising at least one of a fabric, a thread plaiting, and a thread knitting, positioning a separating layer in a contact region between the load-bearing carrier structure and the polymer areal structure at least in section, and the separating layer comprising at least one of wax, starch, oil, and silicone.

### BRIEF DESCRIPTION OF THE DRAWINGS

The present invention is further described in the detailed description which follows, in reference to the noted plurality of drawings by way of non-limiting examples of embodiments of the present invention, in which like reference numerals represent similar parts throughout the several views of the drawings, and wherein:

FIG. 1 illustrates an embodiment of a transport belt according to the present invention shown in section in the CD direction, and

FIGS. 2a and 2b illustrate the transport belt of FIG. 1 shown in section in the MD direction in the unbent (FIG. 2a) and bent (FIG. 2b) state.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

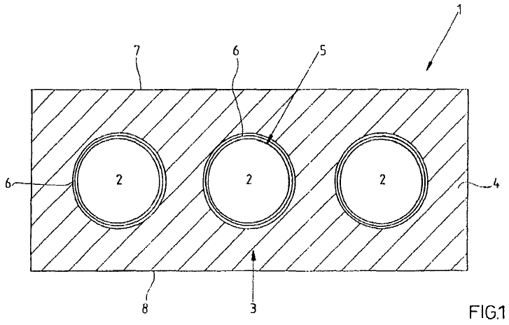

FIG. 1 shows an embodiment of a transport belt 1 according to the present invention, having a load-bearing carrier structure 3 which is formed by a thread arrangement of mutually parallel threads 2 and completely embedded in a polymer areal structure 4.

In this embodiment, the polymer areal structure 4 has a first surface 7 forming the side of the transport belt 1 which can be brought into contact with an article, such as a paper web.

Furthermore, the polymer areal structure 4 has a second surface 8 which lies opposite the first surface 7 and forms the side of the transport belt 1 which can be brought into contact with the machine.

Furthermore, the polymer areal structure 4 can be impermeable to fluid, with the result that the transport belt 1 is also impermeable to fluid.

The embodiment in FIG. 1 shows a section vertical to the length extension of the threads 2, whereby the threads extend in the intended machine direction (MD) of the transport belt 1.

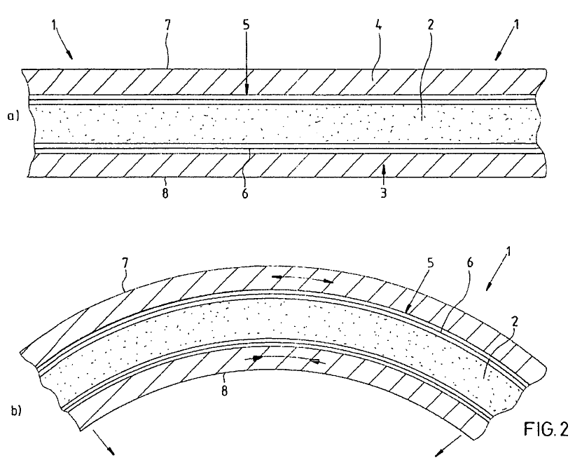

The threads 2 and the polymer areal structure 4 covering the threads 2 form a contact region 5. According to various embodiments of the present invention, the carrier structure 3 can be moved relative to the polymer areal structure 4 in the contact region 5, as is evident in particular from the representation in FIG. 2 for example, which shows a section through the transport belt 1 in the MD direction in the unbent (FIG. 2a) and bent state (FIG. 2b).

In the bent state of the transport belt 1 illustrated in FIG. 2b, the section of the polymer areal structure 2 lying beneath the carrier structure 3 in FIG. 2b is compressed and the part of the polymer areal structure 4 lying above the carrier structure 3 in FIG. 2b is stretched. Because the threads 2 in the contact region 5 extending respectively over the circumferential surface of the threads 2 are movable relative to the polymer areal structure 4, the threads 2 can glide relative to the polymer areal structure 4, thus preventing the strain which would arise given an intrinsic and strong connection between the threads 2 and the polymer areal structure 4. Consequently, the bending rigidity of the transport belt 1 is reduced.

In this embodiment, the relative movability between the carrier structure 3 and the polymer areal structure 4 in the contact region 5 is achieved by positioning, in the contact region 5 between the carrier structure 3 and the polymer areal structure 4, a separating layer 6 which is comprised of a material that provides a reduced frictional resistance between the carrier structure 3 and the polymer areal structure 4 in the contact region 5.

Here, it should be noted that the carrier structure 3 accordingly makes contact with the polymer areal structure 4 indirectly, namely by way of the separating layer 6.

In this embodiment, the separating layer 6 can completely covers the threads 2 respectively along their length extension, and the separating layer 6 being formed by silicone oil.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A transport belt for a web-processing machine comprising a load-bearing carrier structure covered at least in sections by a polymer areal structure, wherein the polymer areal structure and the load-bearing carrier structure make contact with each other in sections either one of indirectly or directly, a contact region being formed between the load-bearing carrier structure and the polymer areal structure, the contact region comprising sections in which the load-bearing carrier structure is movable relative to the polymer areal structure.

2. The transport belt according to claim 1, wherein an adhesive connection is absent between the load-bearing carrier structure and the polymer areal structure in sections where the load-bearing carrier structure is movable relative to the polymer areal structure.

3. The transport belt according to claim 1 wherein the load-bearing carrier structure comprises at least one of a fabric, a thread plaiting, and a thread knitting.

4. The transport belt according to claim 1, wherein a separating layer is positioned in the contact region between the load-bearing carrier structure and the polymer areal structure at least in sections.

5. The transport belt according to claim 4, wherein the load-bearing carrier structure comprises threads and the threads are covered with the separating layer at least in sections.

6. The transport belt according to claim 4, wherein the separating layer comprises a material that provides a reduced frictional resistance between the load-bearing carrier structure and the polymer areal structure in the contact region.

7. The transport belt according to claim 6, wherein the separating layer comprises at least one of wax, starch, oil, and silicone.

8. The transport belt according to claim 1, wherein the polymer areal structure completely covers the load-bearing carrier structure.

9. The transport belt according to claim 1, wherein a first surface of the polymer areal structure forms a first side of the transport belt which contacts with a material web when the material web is placed on the web-processing machine.

10. The transport belt according to claim 9, wherein a second surface of the polymer areal structure lying opposite the first side forms a second side of the transport belt which contacts with the web-processing machine when the transport belt is placed on the web-processing machine.

11. The transport belt according to claim 1, wherein the load-bearing carrier structure and the polymer areal structure are essentially immovable relative to each other in sections of the contact region extending in a transverse direction of the transport belt and the load-bearing carrier structure and the polymer areal structure are movable relative to each other in sections of the contact region extending in a longitudinal direction of the transport belt.

12. The transport belt according to claim 1, wherein the transport belt is impermeable to fluid.

13. The transport belt according to claim 1, wherein the transport belt is configured for one of a paper machine, a paperboard machine or a tissue machine.

14. A transport belt for a web-processing machine comprising:
a load-bearing carrier structure covered at least in sections by a polymer areal structure, wherein the polymer areal structure and the load-bearing carrier structure make contact with each other in sections either one of indirectly or directly;
a contact region being formed between the load-bearing carrier structure and the polymer areal structure, comprising sections wherein the load-bearing carrier structure is moveable relative to the polymer areal structure;
an adhesive connection being absent between the load-bearing carrier structure and the polymer areal structure in sections where the load-bearing carrier structure is moveable relative to the polymer areal structure;
the load-bearing carrier structure comprising at least one of a fabric, a thread plaiting, and a thread knitting;
a separating layer being positioned in a contact region between the load-bearing carrier structure and the polymer areal structure at least in sections; and
the separating layer comprising at least one of wax, starch, oil, and silicone.

15. A method for making a transport belt for a web-processing machine comprising:
providing a load-bearing carrier structure covered at least in sections by a polymer areal structure, wherein the polymer areal structure and the load-bearing carrier structure make contact with each other in sections either one of indirectly or directly; and
forming a contact region between the load-bearing carrier structure and the polymer areal structure, the contact region comprising sections wherein the load-bearing carrier structure is moveable relative to the polymer areal structure.

16. The method of making a transport belt according to claim 15, wherein an adhesive connection is absent between the load-bearing carrier structure and the polymer areal structure in sections where the load-bearing carrier structure is moveable relative to the polymer areal structure.

17. The method of making a transport belt according to claim 15, wherein the load-bearing carrier structure comprises at least one of a fabric, a thread plaiting, and a thread knitting.

18. The method of making a transport belt according to claim 15, further comprising positioning a separating layer in a contact region between the load-bearing carrier structure and the polymer areal structure at least in sections.

19. The method of making a transport belt according to claim 18, wherein the load-bearing carrier structure comprises threads and the threads are covered with the separating layer at least in sections.

20. The method of making a transport belt according to claim 18, wherein the separating layer comprises a material that provides a reduced frictional resistance between the load-bearing carrier structure and the polymer areal structure in the contact region.

21. The method of making a transport belt according to claim 20, wherein the separating layer comprises at least one of wax, starch, oil, and silicone.

22. The method of making a transport belt according to claim 15, wherein the polymer areal structure completely covers the load-bearing carrier structure.

23. The method of making a transport belt according to claim 15, wherein the transport belt is impermeable to fluid.

24. A method of making a transport belt for a web-processing machine comprising:
providing a load-bearing carrier structure covered at least in sections by a polymer areal structure, wherein the polymer areal structure and the load-bearing carrier structure make contact with each other in sections either one of indirectly or directly;
forming a contact region between the load-bearing carrier structure and the polymer areal structure, the contact region comprising sections wherein the load-bearing carrier structure is moveable relative to the polymer areal structure;
an adhesive connection being absent between the load-bearing carrier structure and the polymer areal structure in sections where the load-bearing carrier structure is moveable relative to the polymer areal structure;
the load-bearing carrier structure comprising at least one of a fabric, a thread plaiting, and a thread knitting;
positioning a separating layer in a contact region between the load-bearing carrier structure and the polymer areal structure at least in sections; and
the separating layer comprising at least one of wax, starch, oil, and silicone.
